(19) United States
(12) Patent Application Publication
(10) Pub. No.: US 2015/0228151 A1
(43) Pub. Date: Aug. 13, 2015

(54) SYSTEM AND METHOD FOR ENHANCING PLAYER EXPERIENCE USING SOCIAL MEDIA DATA

(71) Applicant: Bally Gaming, Inc., Las Vegas, NV (US)

(72) Inventor: Prithiviraj Damodaran, Chennai (IN)

(73) Assignee: Bally Gaming, Inc., Las Vegas, NV (US)

(21) Appl. No.: 14/176,974

(22) Filed: Feb. 10, 2014

(51) Int. Cl. G07F 17/32

(52) U.S. Cl. CPC G07F 17/3225; G07F 17/3244

(57) ABSTRACT

A method is disclosed of enabling a player to use a social-media enhanced kiosk system to obtain an enhanced gaming experience using player preference services. The method includes: enabling a player to access the social-media enhanced kiosk system; enabling a social account of the player on a social network to be accessed, wherein social data is retrieved from the social account of the player on the social network and transferred to a database within the social-media enhanced kiosk system; formatting and storing the social data; processing the social data; enabling the processed social data in the social-media enhanced kiosk system to be searched.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

This disclosure is directed to wagering kiosks, gaming machines, networked systems and methods and, more particularly, to kiosks, gaming machines, networked systems and methods having incorporated social media components.

### BACKGROUND

Two major areas of interest for casinos include understanding what their players want and determining how to keep in touch with the player effectively and cheaply. For a casino to provide a personalized in-floor experience, it is valuable for a casino to understand its players and potential players (e.g., what the players do, what the players like, what places the players visit, and things the players buy outside the gaming floor). This may be as simple as serving the right drink or as sophisticated as creating appropriately targeted promotions.

Conventional methods of asking for this type of information, as well as capturing player contacts and/or player preferences, are becoming obsolete since an insufficient amount of players take the time to share this information with a casino. Without knowing a player's personal, gaming, and/or non-gaming preferences, providing a complete personalized experience is exceedingly difficult. There is a continuing need for methods to enable casinos to acquire player preferences and information to give the casinos a better chance at attracting and retaining players.

### SUMMARY

Briefly, and in general terms, a method is disclosed of enabling a player to use a social-media enhanced kiosk system to obtain an enhanced gaming experience using personal player data from a social network. The method includes: enabling a player to access the social-media enhanced kiosk system via a user interface; enabling a social account of the player on a social network to be accessed, wherein social data is retrieved from the social account of the player on the social network and transferred to a database within the social-media enhanced kiosk system; formatting and storing the social data, wherein the social data is stored as a transaction and associated with a transaction type and player account; processing the social data and transaction type; loading a data queue with the processed social data, wherein the social data is associated with an access token and transaction type; and enabling asynchronous queue polling of the processed social data.

In another embodiment, a method is disclosed of enabling a player to use a social-media enhanced kiosk system to obtain an enhanced gaming experience using player preference data from a social network. The method includes: enabling a player to access the social-media enhanced kiosk system; enabling a social account of the player on a social network to be accessed, wherein social data is retrieved from the social account of the player on the social network and transferred to a database within the social-media enhanced kiosk system; formatting and storing the social data; processing the social data; loading a data queue with the processed social data; and enabling asynchronous queue polling of the processed social data in the social-media enhanced kiosk system.

In still another embodiment, a method is disclosed of enabling a player to use a social-media enhanced kiosk system to obtain an enhanced gaming experience using player preference services. The method includes: enabling a player to access the social-media enhanced kiosk system; enabling a social account of the player on a social network to be accessed, wherein social data is retrieved from the social account of the player on the social network and transferred to a database within the social-media enhanced kiosk system; formatting and storing the social data; processing the social data; enabling the processed social data in the social-media enhanced kiosk system to be searched.

Features and advantages will become apparent from the following detailed description, taken in conjunction with the accompanying drawings, which illustrate by way of example, the features of the various embodiments.

### BRIEF DESCRIPTION OF THE DRAWINGS

FIG. 1 illustrates an uncarded player performing a social network login for the player experience use embodiment.

FIG. 2 illustrates a carded player during a first-time, social network login for the player preference/personal data synchronizing embodiment.

FIG. 3 illustrates a ranking of social network objects for building player preference database.

FIG. 4 illustrates a social media integration flow for capturing player preferences from a social network.

FIG. 5 illustrates a sample FACEBOOK access permission screen.

FIG. 6 is a perspective view of a gaming machine in accordance with one or more embodiments.

FIGS. 7a-7b are block diagrams of the physical and logical components of the gaming machine in FIG. 6 in accordance with one or more embodiments.

FIG. 8 is a block diagram of the logical components of a gaming kernel in accordance with one or more embodiments.

FIG. 9 is a schematic block diagram showing the hardware elements of a networked kiosk system in accordance with one or more embodiments.

FIG. 10 is a schematic block diagram showing the hardware elements of a networked kiosk system in accordance with one or more embodiments.

FIG. 11 is a schematic block diagram showing the hardware elements of a tournament kiosk system employing social network based team formation.

FIG. 12 is a logic flow diagram of a tournament kiosk system employing social network based team formation.

FIG. 13 is another logic flow diagram of a tournament kiosk system employing social network based team formation.

### DETAILED DESCRIPTION OF PREFERRED EMBODIMENTS

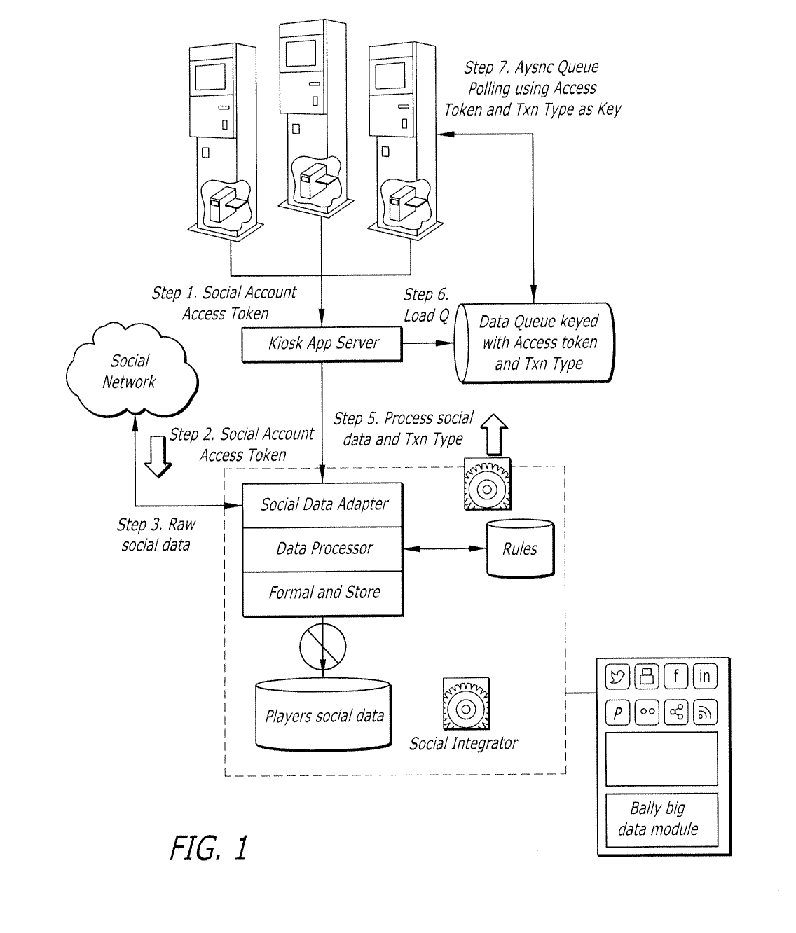

Various embodiments are directed to a game, a gaming machine, gaming networks and a method for playing a game, wherein the game includes a social-media enhanced kiosk system. The embodiments are illustrated and described herein by way of example only, and not by way of limitation. Referring now to the drawings, and more particularly to FIGS. 1-5, 14-21, there are shown illustrative examples of games, gaming machines, gaming networks and methods for playing a game in accordance with various aspects of the kiosk system.

Referring now to FIGS. 1-5, a system and method is described for a social-media enhanced kiosk system 100 that enhances player experience by personalization and preference tracking from social media data. Several embodiments of the system and method are described for a social-media enhanced kiosk system 100 that includes the following functionalities. These include player experience services, player personal data synchronizing, and player preferences data synchronizing. In other embodiments, the described system and method are incorporated in a social-media enhanced gaming system.

In some embodiments, social media integration from the game floor is an approved and accepted concept/feature by various regulations and operators. The leveraging of social data is flexible enough to handle different forms of social data and is not limited to any single social network form. Player preferences services and personal data sync services are reserved only for carded players, while the player experience services are extended for both carded and un-carded players. Notably, most accepted social networks use OAUTH 2.0 concepts for authenticating. In the following examples, Facebook is utilized as the illustrative social network.

Player Experience Services:

In one embodiment, a player that is socially active on one or more social networks may enable access to their social database using the social-media enhanced kiosk system 100. Using the social-media enhanced kiosk system 100 to access the social database enables casinos to elevate the player experience to a new level of personalized services. For example, in one embodiment of the social-media enhanced kiosk system 100, a change in “relationship status” of the player may be used to send an appropriate personalized greeting to the player. Additionally, as a result of the change in “relationship status” of the player, the responding personalized greeting to the player may provide an option to invite the player's new partner to the casino.

In another embodiment of the social-media enhanced kiosk system 100, the player's “religion” attribute may be directly taken from a player's social database and used to associate an appropriate theme to a bonus game, send a seasonal greeting at card-in, and/or invite friends or family of the player to a seasonal event. In still another embodiment of the social-media enhanced kiosk system 100, the player's “language(s)” attribute may be directly taken from a player's social database and can be used as a default in Kiosk (or gaming device). Every key stroke saved (by not having to set up the player's language preference) is enhancing the player experience.

Referring now to FIG. 1, the steps of a method are shown for an uncarded player performing a social network login in the player experience use embodiment. In steps 1 and 2, the social account is accessed from the network. In steps 3, the raw social data is retrieved and transferred to a database within the social-media enhanced kiosk system 100. In step 4, the raw social data is formatted and stored as a transaction. In one embodiment, the raw social data is stored as a transaction with a transaction type and player account. In step 5, the social data and transaction type are processed. In step 6, the data queue is loaded with an access token and transaction type. In step 7, asynchronous queue polling is performed using an access token and transaction type.

Player Personal Data Synchronization:

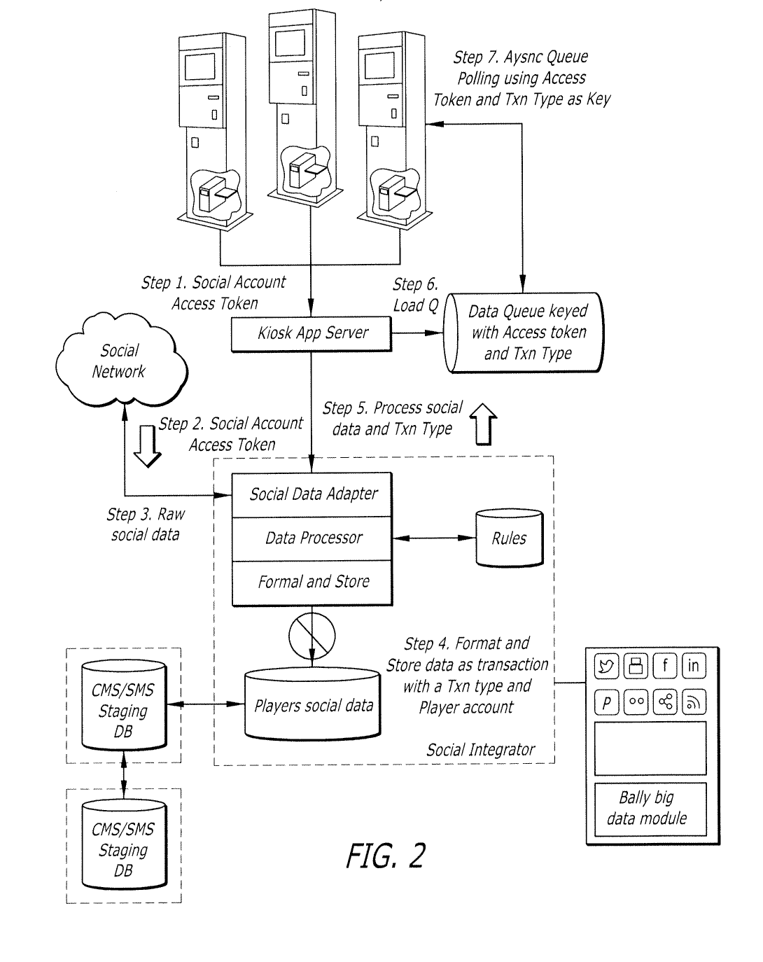

Referring now to FIG. 2, the steps of a method are shown for a carded player during a first-time, social network login for the player preference/personal data synchronizing embodiment. The first category of player data synchronization in the social-media enhanced kiosk system 100 is player personal data synchronization. Player personal data synchronization of the social-media enhanced kiosk system 100 enables casinos to continuously acquire player personal data for a player database which practically never goes out of date (due to the continuous updating from the social network data). Instead, the player personal data synchronization of the social-media enhanced kiosk system 100 enables players to be constantly updating their personal information without any additional effort on the part of the players. In this manner, the social-media enhanced kiosk system 100 improves the effectiveness of the marketing efforts in reaching targeted player segments.

By using the social-media enhanced kiosk system 100, players may leverage their social data from one or more social network databases when enrolling for a new player card. Simply stated, using the social-media enhanced kiosk system 100 players can log in to their social network account and have required data prefilled in the registration screen at the casino. With the social-media enhanced kiosk system 100, players just have to change/verify the data displayed and clicks submit. Thereby, saving players a lot of time and effort during the registration process.

In one embodiment of the social-media enhanced kiosk system 100, each time the player logs-in to his/her social network account in a self-service kiosk and uses a social media related feature like “liking” a promotional event or a coupon, the system cross checks the social network account “updated time” and “time zone” objects. The social-media enhanced kiosk system 100 then compares this information with CMS/SMS personal data from the last updated time. If the social network data has updated information, the social-media enhanced kiosk system 100 automatically synchronizes the data with player's “permission.” The player can set up “permissions” in advance to determine how much automated activity the player would like the social-media enhanced kiosk system 100 to perform.

Referring again to FIG. 2, this illustration of the social-media enhanced kiosk system 100 shows how the social integrator component is deployed in an isolated fashion from the rest of CMS/SMS systems and databases for regulatory and security reasons. The social data captured from the players social data account is stored in a separate database of the social-media enhanced kiosk system 100. In one embodiment, a typical social network “user” object has the following vital fields: locale, gender, favorite teams, favorite athlete, interested in, birthday, age range, languages, religion, relationship status, work, location, hometown, education, email, devices, and currency.

Player Preferences Data Synchronization:

The second category of player data synchronization in the social-media enhanced kiosk system 100 is player preference data synchronization. Player preference data synchronization of the social-media enhanced kiosk system 100 enables casinos to know the constantly changing player moods, preferences for games, entertainment and media. This feature of the social-media enhanced kiosk system 100 also helps in creating effective and instant floor wide promotions or giving appropriate bonus games.

Using the social-media enhanced kiosk system 100, a casino may track the game types or games played by player in social network. This provides a good starting point to determine what kind of games the player prefers at different times of the year. The social-media enhanced kiosk system 100 enables a casino to derive accurate player preferences across different areas right from information acquired via the social network. The information may include: (1) lists of favorite hangouts which the player has recently “checked into,” (2) choice of airways, (3) preferred sport, and (4) game types in which the player has reached new high scores.

In one embodiment of the social-media enhanced kiosk system 100, when the system is about to present the player a bonus game, the player's “game preferences” may be utilized to decide the type of the game to offer the player. The player's FACEBOOK (or other social network) “activities,” “games,” and “scores” may all be utilized to create a player “game preference.” In another embodiment of the social-media enhanced kiosk system 100, when the player is in a promotions screen, the list of dining coupons to be redeemed is listed based on players “dining preferences.” The player's FACEBOOK (or other social network) “locations,” “check-ins,” and “events” may all be utilized to create a player “dinning preference.”

Referring again to FIG. 2, this illustration of the social-media enhanced kiosk system 100 shows how the social integrator component is deployed and depicts the entire flow of social data from the social network to social-media enhanced kiosk system 100 and throughout the system. Once the player logs into his/her social network account (e.g., to participate in a “like n win” promotion) the underlying “access token” along with the player account flows into the Kiosk App server. The Kiosk App server communicates the same information to the social integrator service. The above steps are asynchronous so the kiosk client does not make the player wait. In this regard, a player may have actually selected the “liked” virtual button and won a promotion in the meantime.

As shown in FIG. 2, the social integrator component of the social-media enhanced kiosk system 100 then takes the “account number” and “access token” to access the social network account. The social integrator component then processes, generates, and aggregates the preference data into the preference database. The preference data is keyed with the player account number and a unique transaction type. The transaction type may be, for example, “DP” for “Dinning preferences” or other similar transaction type. In one embodiment, the preference data is stored in a custom JSON format. In other embodiments, other formats are used. The processed social data is then sent back to Kiosk App server for storing in a data queue that is indexed with unique keys. Kiosk clients use the keys to uniquely identify queued data appropriately for fetching and using the data. The kiosk clients may also poll the queue, which is located in the Kiosk App server hardware, based on user navigation.

In another embodiment of the social-media enhanced kiosk system 100, if the player navigates into the promotions screen, kiosk client polls the data queue for “gaming preferences” and “dinning preferences” to see if there are matching records for the current player account number. If any matching records exist then the social-media enhanced kiosk system 100 uses the data to render the user interface, thereby bringing the right choice of bonus promotional games and coupons to the first page. By using the social-media enhanced kiosk system 100, every player who uses a social login at the kiosk may have their entire kiosk experience based on their social preferences. After first login, the subsequent uses will be much faster with the player's latest preferences being appropriately used on appropriate screens that players have accessed.

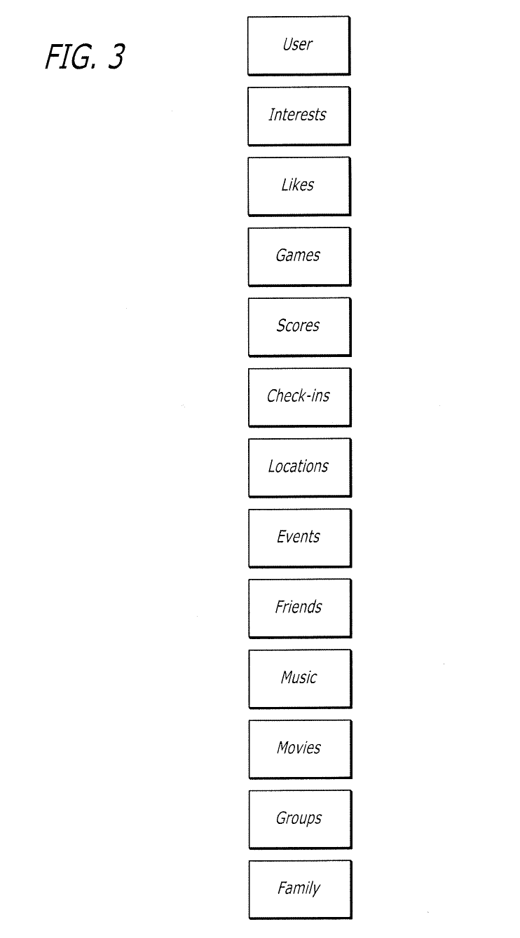

Referring now to FIG. 3, a ranking of social network objects for building a player preference database is shown. In one embodiment of the social-media enhanced kiosk system 100, social data from the social network is stored in the database. The social-media enhanced kiosk system 100 enables the use of player preference services. Player preference services are designed to expose all of the player-related, social preference data as on-demand services. In this regard, a player preference service is a secure service accessible only inside the operator's network. The player preference service takes a player account number and transaction type as inputs and returns one or more preference from the preference database. In one embodiment, this service is hosted using the same hardware where the social integrator module is hosted. Notably, the use of the player preference service and the social-media enhanced kiosk system 100 is not limited to use with kiosks. Any application (e.g., gaming machine application) may use the player preference data through this service with a valid API access key.

Advantageously, the social-media enhanced kiosk system 100 improves the player experience since the system knows the player preferences for every touch point interaction by the player and enables accurate targeted promotions to be provided. Additionally, activities that were previously time-consuming (e.g., player card registration), may now be completed in a few clicks if players leverage their social data using the social-media enhanced kiosk system 100. Moreover, the social-media enhanced kiosk system 100 improves the “walk-in” player's experience by leveraging the player's social network.

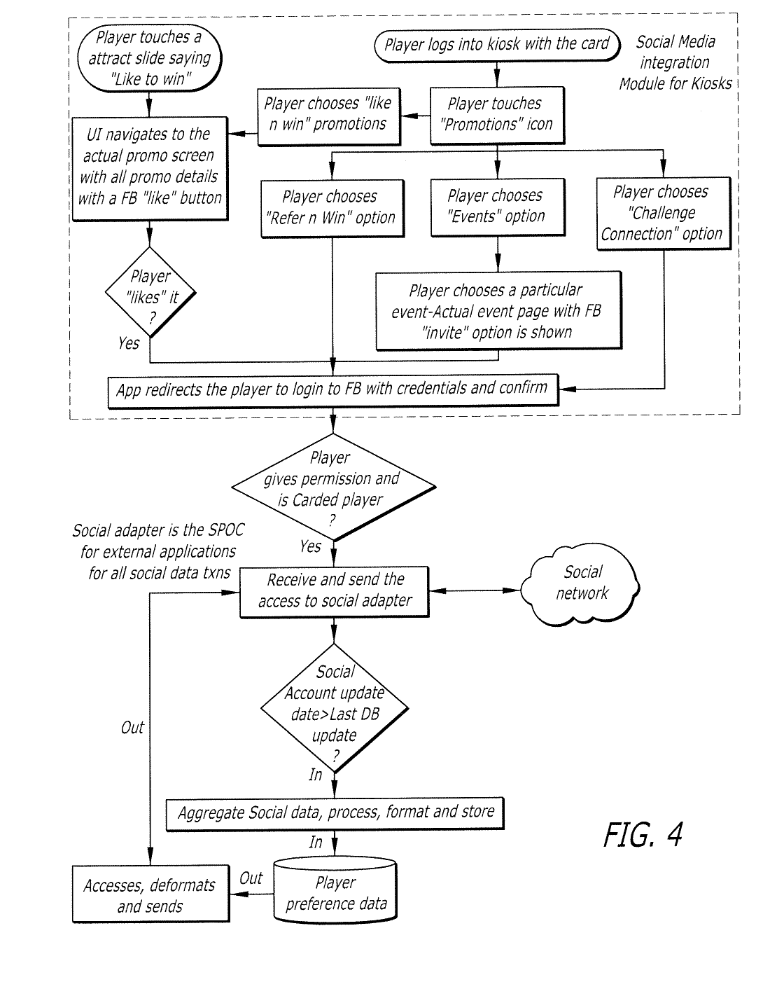

Referring now to FIG. 4, a social media integration flow for capturing player preferences from a social network is shown. In FIG. 4, a player logs into a kiosk with their player card. The player then touches a “promotions” icon. Next, the player chooses a “refer to win” option, an “events” option, or a “challenge connection” option. After the player chooses a particular event, an actual event page with a FACEBOOK (for example) “invite” option is shown.

Alternatively, a player may touch an attract slide saying “like to win.” Then the User interface navigates to the actual promotion screen with all promotional details with a FACEBOOK (for example) “like” button. The player would then select the “like” button to advance to the next stage.

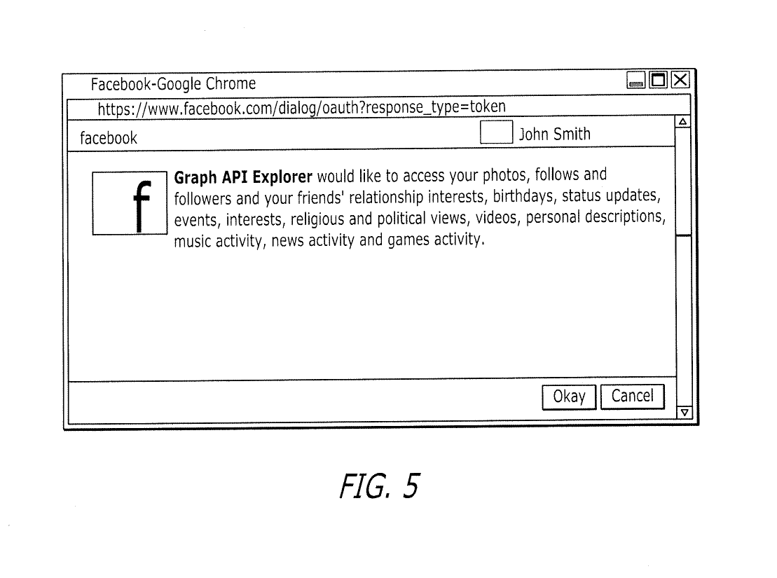

Continuing, the Application redirects the player to login to FACEBOOK (or other social network) with their credentials and confirm their selections, as shown in FIG. 5. The system then confirms that the player has given permission for the social data to be retrieved from the social network and that the player is carded by the casino. Next, the social data is received from the social network and sent to the social adapter. At this point, the system determines the date of the last social account update and updates the database if required. The system then aggregates, processes, formats, and stores the social data in the player preference database. Finally, the player preference data may now be accessed, de-formatted, and sent, as required by queue polling.

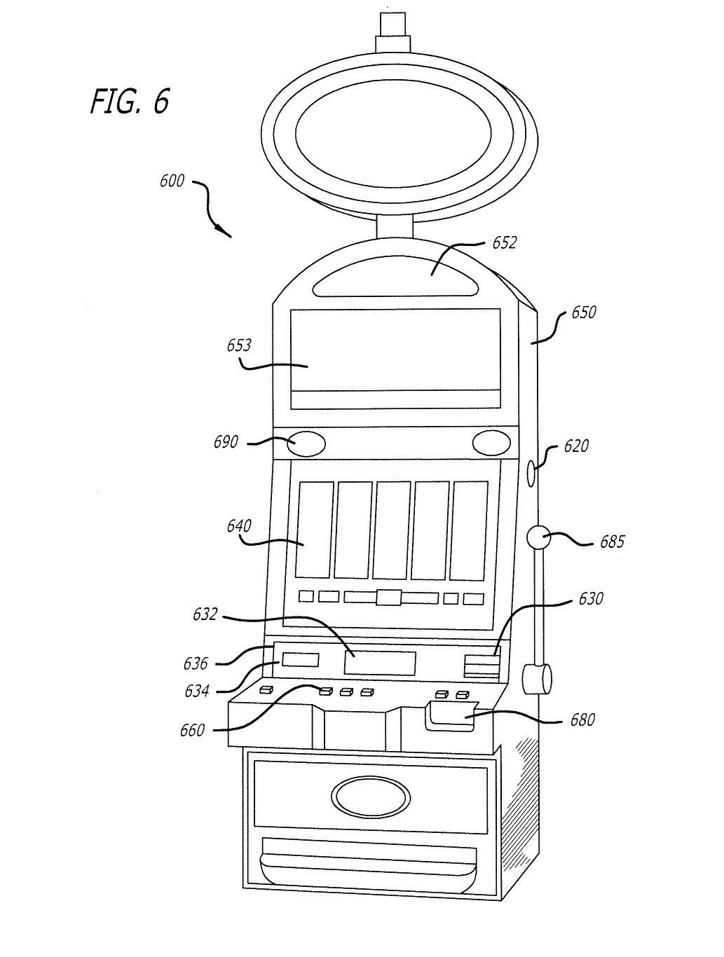

Referring to FIG. 6, the gaming machine 600 is capable of supporting various embodiments of the social-media enhanced kiosk system 100, including cabinet housing 620, primary game display 640 upon which a primary game and feature game may be displayed, top box 650 which may display multiple progressives that may be won during play of the feature game, player-activated buttons 660, player tracking panel 636, bill/voucher acceptor 680, and one or more speakers 690. Cabinet housing 620 may be a self-standing unit that is generally rectangular in shape and may be manufactured with reinforced steel or other rigid materials which are resistant to tampering and vandalism. Cabinet housing 620 may alternatively be a handheld device including the gaming functionality as discussed herein and including various elements of the described components herein. For example, a handheld device may be a cell phone, personal data assistant, or laptop or tablet computer, each of which may include a display, a processor, and memory sufficient to support either stand-alone capability, such as gaming machine 400, or thin client capability, such as that incorporating some of the capability of a remote server.

In one or more embodiments, cabinet housing 620 houses a processor, circuitry, and software (not shown) for receiving signals from the player-activated buttons 660, operating the games, and transmitting signals to the respective displays and speakers. Any shaped cabinet may be implemented with any embodiment of gaming machine 600 so long as it provides access to a player for playing a game. For example, cabinet 620 may comprise a slant-top, bar-top, or table-top style cabinet, including a Bally Cinevision™ or CineReels™ cabinet. The operation of gaming machine 600 is described more fully below.

The plurality of player-activated buttons 660 may be used for various functions such as, but not limited to, selecting a wager denomination, selecting a game to be played, selecting a wager amount per game, initiating a game, or cashing out money from gaming machine 400. Buttons 460 may be operable as input mechanisms and may include mechanical buttons, electromechanical buttons or touch screen buttons. Optionally, a handle 685 may be rotated by a player to initiate a game.

In one or more embodiments, buttons 660 may be replaced with various other input mechanisms including, but not limited to, a touch screen system, touch pad, track ball, mouse, switches, toggle switches, or other input means used to accept player input such as a Bally iDeck™. One other example input means is a universal button module as disclosed in U.S. patent application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

In one embodiment, the cabinet housing 620 may optionally include top box 650 which contains “top glass” 652 comprising advertising or payout information related to the game or games available on gaming machine 600. Additionally, the player tracking panel 636 may include a player tracking card reader 634 and a player tracking display 632. Continuing, a voucher printer 630 may be integrated into player tracking panel 636 or installed elsewhere in cabinet housing 620 or top box 650.

In another aspect of one embodiment, a game display 640 may present a game of chance wherein a player receives one or more outcomes from a set of potential outcomes. For example, one such game of chance is a video slot machine game. In other aspects of the embodiment, the gaming machine 600 may present a video or mechanical reel slot machine, a video keno game, a lottery game, a bingo game, a Class II bingo game, a roulette game, a craps game, a blackjack game, a mechanical or video representation of a wheel game, or the like.

Mechanical or video/mechanical embodiments may include game displays such as mechanical reels, wheels, or dice as required to present the game to the player. In video/mechanical or pure video embodiments, game display 640 is typically a CRT or a flat-panel display in the form of, but not limited to liquid crystal, plasma, electroluminescent, vacuum fluorescent, field emission, or any other type of panel display known or developed in the art. Game display 640 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 440 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference.

Game display 640 may also present information such as, but not limited to, player information, advertisements and casino promotions, graphic displays, news and sports updates, or even offer an alternate game. This information may be generated through a host computer networked with gaming machine 600 on its own initiative, or it may be obtained by request of the player using either one or more of the plurality of player-activated buttons 660; the game display itself, if game display 640 comprises a touch screen or similar technology; buttons (not shown) mounted about game display 640 which may permit selections such as those found on an ATM machine, where legends on the screen are associated with respective selecting buttons; or any player input device that offers the required functionality.

Cabinet housing 620 incorporates a single game display 640. However, in alternate embodiments, cabinet housing 620 or top box 650 may house one or more additional displays 653 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

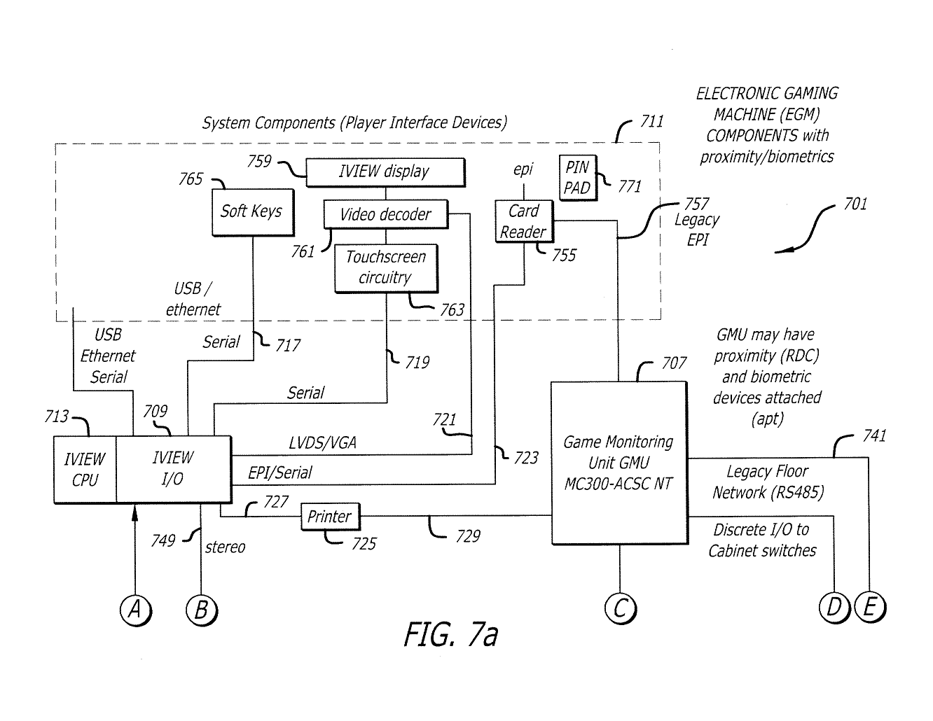

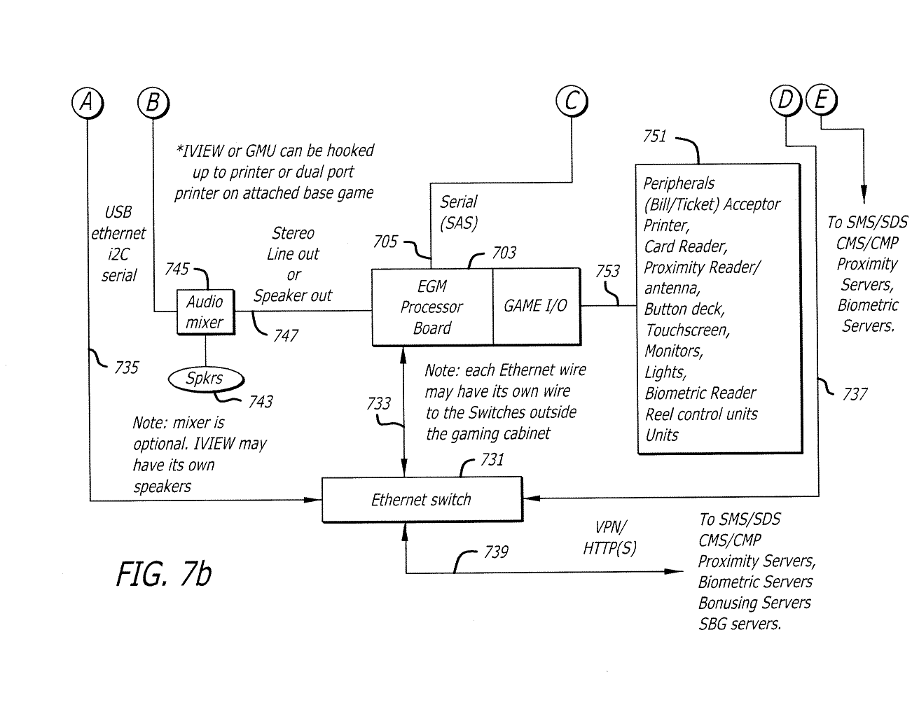

Referring to FIGS. 7a-7b, electronic gaming machine (EGM) 701 is shown in accordance with one or more embodiments. EGM 701 includes a base game integrated circuit board 703 (EGM Processor Board) connected through a serial bus line 705 to game monitoring unit (GMU) 707 (such as a Bally MC300 or ACSC NT), and a player interface integrated circuit board (PIB) 709 connected to player interface devices 711 over bus lines 713, 77, 717, 719, 721, 723. Printer 725 is connected to PIB 709 and GMU 707 over bus lines 727, 729. Base game integrated circuit board 703, PIB 709, and GMU 707 connect to Ethernet switch 731 over bus lines 733, 735, 737. Ethernet switch 731 connects to a slot management system (SMS) and a casino management system (CMS) network over bus line 739. GMU 707 also may connect to the SMS and CMS network over bus line 741. Speakers 743 connect through audio mixer 745 and bus lines 747, 749 to base game integrated circuit board 703 and PIB 709. The proximity and biometric devices and circuitry may be installed by upgrading a commercially available PIB 709, such as a Bally iView unit. Coding executed on base game integrated circuit board 703, PIB 709, and/or GMU 707 may be upgraded to integrate a game having adjustable, multi-part, indicia as is more fully described herein.

Peripherals 751 connect through I/O board 753 to base game integrated circuit board 703. For example, a bill/ticket acceptor is typically connected to a game input-output board 753 which is, in turn, connected to a conventional central processing unit (“CPU”) base game integrated circuit board 703, such as an Intel Pentium microprocessor mounted on a gaming motherboard. I/O board 753 may be connected to a base game integrated circuit board 703 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. Base game integrated circuit board 703 executes a game program that causes base game integrated circuit board 703 to play a game. In one embodiment, the game program provides a slot machine game having adjustable multi-part indicia. The various components and included devices may be installed with conventionally and/or commercially available components, devices, and circuitry, into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 753 to base game integrated circuit board 703 which, in turn, assigns an appropriate number of credits for play in accordance with the game program. The player may further control the operation of the gaming machine by way of other peripherals 751, for example, to select the amount to wager via electromechanical or touch screen buttons. The game starts in response to the player operating a start mechanism, such as a handle or touch screen icon. The game program includes a random number generator to provide a display of randomly-selected indicia on one or more displays.

In some embodiments, the random generator may be physically separate from gaming machine 700. For example, the random generator may be part of a central determination host system which provides random game outcomes to the game program. Thereafter, the player may or may not interact with the game through electromechanical or touch screen buttons to change the displayed indicia. Finally, the base game integrated circuit board 703 is under control of the game program, and the OS compares the final display of indicia to a pay table. The set of possible game outcomes may include a subset of outcomes related to the triggering of a feature game. In the event the displayed outcome is a member of this subset, the base game integrated circuit board 703, under control of the game program and by way of I/O Board 753, may cause feature game play to be presented on a feature display.

Predetermined payout amounts for certain outcomes, including feature game outcomes, are stored as part of the game program. Such payout amounts are, in response to instructions from base game integrated circuit board 703, provided to the player in the form of coins, credits or currency via I/O board 753 and a pay mechanism, which may be one or more of a credit meter, a coin hopper, a voucher printer, an electronic funds transfer protocol, or any other payout means known or developed in the art.

In various embodiments, the game program is stored in a memory device (not shown) connected to, or mounted on, the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 707 includes an integrated circuit board and GMU processor and memory including coding for network communications, such as the G2S (game-to-system) protocol from the Gaming Standards Association, Las Vegas, Nev., used for system communications over the network. As shown, GMU 707 may connect to card reader 755 through bus 757 and may thereby obtain player card information and transmit the information over the network through bus 741. Gaming activity information may be transferred by the base game integrated circuit board 703 to GMU 707 where the information may be translated into a network protocol, such as S2S, for transmission to a server, such as a player tracking server, where information about a player's playing activity may be stored in a designated server database.

PIB 709 includes an integrated circuit board, PID processor, and memory which includes an operating system, such as Windows CE, a player interface program which may be executable by the PID processor together with various input/output (I/O) drivers for respective devices which connect to PIB 709, such as player interface devices 511, and which may further include various games or game components playable on PIB 709 or playable on a connected network server and PIB 709 is operable as the player interface. PIB 709 connects to card reader 755 through bus 723, display 759 through video decoder 761 and bus 721, such as an LVDS or VGA bus.

As part of its programming, the PID processor executes coding to drive display 759 and provide messages and information to a player. Touch screen circuitry interactively connects display 759 and video decoder 761 to PIB 709, such that a player may input information and cause the information to be transmitted to PIB 709 either on the player's initiative or responsive to a query by PIB 709. Additionally, soft keys 765 connect through bus 717 to PIB 709 and operate together with display 759 to provide information or queries to a player and receive responses or queries from the player. PIB 709, in turn, communicates over the CMS/SMS network through Ethernet switch 731 and busses 735, 739 and with respective servers, such as a player tracking server.

Player interface devices 711 are linked into the virtual private network of the system components in gaming machine 701. The system components include the iVIEW processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, and gaming machine configurations can be downloaded to the system components from the servers. This data is authenticated prior to installation on the system components.

The system components include the iVIEW processing board and game monitoring unit (GMU) processing board. The GMU and iVIEW can be combined into one device (e.g., the commercially available Bally GTM iVIEW device). This device may have a video mixing technology to mix the EGM processor's video signals with the iVIEW display onto the top box monitor or any monitor on the gaming device.

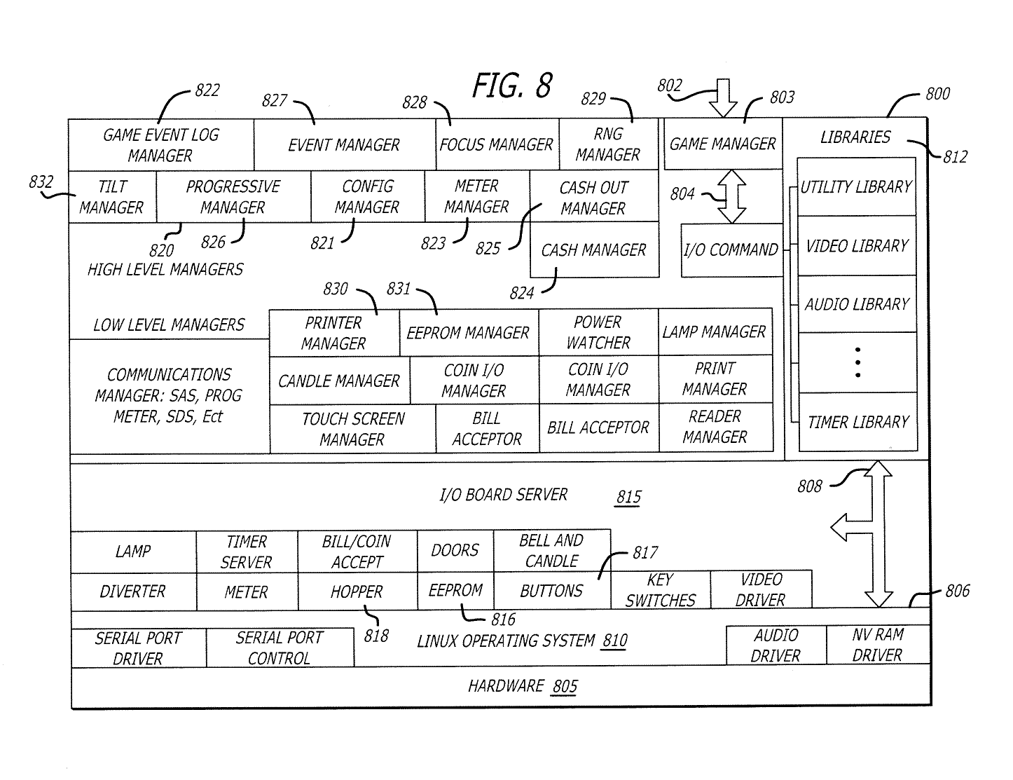

In accordance with one or more embodiments, FIG. 8 is a functional block diagram of a gaming kernel 800 of a game program under control of base game integrated circuit board 703. The game program uses gaming kernel 800 by calling into application programming interface (API) 802, which is part of game manager 803. The components of game kernel 800, as shown in FIG. 8, are only illustrative and should not be considered limiting. For example, the number of managers may be changed, additional managers may be added or some managers may be removed without deviating from the scope and spirit of the disclosed embodiments.

As shown in the example, there are three layers: a hardware layer 805; an operating system layer 810, such as, but not limited to, Linux; and a game kernel layer 800 having game manager 803 therein. In one or more embodiments, the use of a standard operating system 810, such as a UNIX-based or a Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 800 executes at the user level of the operating system 810, and itself contains a major component called the I/O Board Server 815. To properly set the bounds of game application software (making integrity checking easier), all game applications interact with gaming kernel 800 using a single API 802 in game manager 803. This enables game applications to make use of a well-defined, consistent interface, as well as making access points to gaming kernel 800 controlled, where overall access is controlled using separate processes.

For example, game manager 803 parses an incoming command stream and, when a command dealing with I/O comes in (arrow 804), the command is sent to an applicable library routine 812. Library routine 812 decides what it needs from a device and sends commands to I/O Board Server 815 (see arrow 808). A few specific drivers remain in operating system kernel, shown as those below line 806. These are built-in, primitive, or privileged drivers that are (i) general, (ii) kept to a minimum, and (iii) are easier to leave than extract. In such cases, the low-level communications is handled within operating system 810, and the contents are passed to library routines 812.

Thus, in a few cases library routines may interact with drivers inside operating system 810, which is why arrow 808 is shown as having three directions (between library utilities 812 and I/O Board Server 815, or between library utilities 812 and certain drivers in operating system 810). No matter which path is taken, the logic needed to work with each device is coded into modules in the user layer of the diagram. Operating system 810 is kept as simple, stripped down, and common across as many hardware platforms as possible. The library utilities and user-level drivers change as dictated by the game cabinet or game machine in which it runs. Thus, each game cabinet or game machine may have a base game integrated circuit board 703 connected to a unique, relatively dumb, and as inexpensive as possible I/O adapter board 740, plus a gaming kernel 800 which has the game-machine-unique library routines and I/O Board Server 815 components needed to enable game applications to interact with the gaming machine cabinet. Note that these differences are invisible to the game application software with the exception of certain functional differences (e.g., if a gaming cabinet has stereo sound, the game application makes use of API 802 to use the capability over that of a cabinet having traditional monaural sound).

Game manager 803 provides an interface into game kernel 800, providing consistent, predictable, and backwards-compatible calling methods, syntax, and capabilities by way of game application API 802. This enables the game developer to be free of dealing directly with the hardware, including the freedom to not have to deal with low-level drivers as well as the freedom to not have to program lower-level managers 830, although lower-level managers 830 may be accessible through game manager's interface 802 if a programmer has such a need. In addition to the freedom derived from not having to deal with the hardware level drivers and the freedom of having consistent, callable, object-oriented interfaces to software managers of those components (drivers), game manager 803 provides access to a set of upper level managers 820 also having the advantages of consistent callable, object-oriented interfaces, and further providing the types and kinds of base functionality required in casino-type games. Game manager 803, providing all the advantages of its consistent and richly functional interface 802 as supported by the rest of game kernel 800, thus providing a game developer with a multitude of advantages.

Game manager 803 may have several objects within itself, including an initialization object (not shown). The initialization object performs the initialization of the entire game machine, including other objects, after game manager 803 has started its internal objects and servers in appropriate order. In order to carry out this function, the kernel's configuration manager 821 is among the first objects to be started; configuration manager 821 has data needed to initialize and correctly configure other objects or servers.

The upper level managers 820 of game kernel 800 may include game event log manager 822 which provides, at the least, a logging or logger base class, enabling other logging objects to be derived from this base object. The logger object is a generic logger. Otherwise stated, the logger object is not aware of the contents of logged messages and events. The log manager's (822) job is to log events in a non-volatile event log space. The size of the space may be fixed, although the size of the logged event is typically not fixed. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 823 manages the various meters embodied in the game kernel 800. This includes the accounting information for the game machine and game play. There are hard meters (counters) and soft meters. The soft meters may be stored in non-volatile storage, such as non-volatile battery-backed RAM to prevent loss. Further, a backup copy of the soft meters may be stored in a separate, non-volatile storage such as EEPROM. In one embodiment, meter manager 823 receives its initialization data for the meters, during startup, from configuration manager 821. While running, the cash in (824) and cash out (825) managers call the meter manager's (823) update functions to update the meters. Meter manager 823 will, on occasion, create backup copies of the soft meters by storing the soft meters' readings in EEPROM. This is accomplished by calling and using EEPROM manager 831.

In accordance with still other embodiments, the progressive manager 826 manages progressive games playable from the game machine. The event manager 827 is generic, like log manager 822, and is used to manage various gaming machine events. The focus manager 828 correlates which process has control of various focus items. The tilt manager 832 is an object that receives a list of errors (if any) from configuration manager 821 at initialization, and during game play from processes, managers, drivers, and the like, that may generate errors. Random number generator manager 829 is provided to allow easy programming access to a random number generator (RNG), as a RNG is required in virtually all casino-style (gambling) games. RNG manager 829 includes the capability of using multiple seeds.

In accordance with one or more embodiments, a credit manager object (not shown) manages the current state of credits (cash value or cash equivalent) in the game machine, including any available winnings, and further provides denomination conversion services. The cash out manager 825 has the responsibility of configuring and managing monetary output devices. During initialization, the cash out manager 825, using data from configuration manager 821, sets the cash out devices correctly and selects any selectable cash out denominations. During play, a game application may post a cash out event through the event manager 827 (the same way all events are handled), and using a callback posted by cash out manager 825, cash out manager 825 is informed of the event.

The cash out manager 825 updates the credit object, updates its state in non-volatile memory, and sends an appropriate control message to the device manager that corresponds to the dispensing device. As the device dispenses dispensable media, there will typically be event messages being sent back and forth between the device and cash out manager 825 until the dispensing finishes. After this point, the cash out manager 825, having updated the credit manager and any other game state (such as some associated with meter manager 823) that needs to be updated for this set of actions, sends a cash out completion event to event manager 827 and to the game application. The cash in manager 824 functions similarly to cash out manager 825, only controlling, interfacing with, and taking care of actions associated with cashing in events, cash in devices, and associated meters and crediting.

In a further embodiment, in accordance with one or more embodiments, I/O server 815 may write data to the gaming machine EEPROM memory, which is located in the gaming machine cabinet and holds meter storage that must be kept even in the event of power failure. The game manager 803 calls the I/O library functions to write data to the EEPROM. The I/O server 815 receives the request and starts a low priority EEPROM thread 816 within I/O server 815 to write the data. This thread uses a sequence of 8-bit commands and data writes to the EEPROM device to write the appropriate data in the proper location within the device. Any errors detected are sent as IPC messages to game manager 803. Typically, all of this processing is asynchronous.

In accordance with one embodiment, button module 817 within I/O server 815, polls (or is sent) the state of buttons every 2 milliseconds. These inputs are debounced by keeping a history of input samples. Certain sequences of samples are required to detect that a button was pressed, in which case the I/O server 815 sends an inter-process communication event to the game manager 803 that a button was pressed or released. In some embodiments, the gaming machine may have intelligent distributed I/O which debounces the buttons, in which case button module 817 may be able to communicate with the remote intelligent button processor to get the button events and simply relay them to the game manager 803 via IPC messages. In still another embodiment, the I/O library may be used for pay out requests from the game application. For example, hopper module 818 must start the hopper motor, constantly monitor the coin sensing lines of the hopper, debounce them, and send an IPC message to the game manager 803 when each coin is paid.

Further details, including disclosure of lower-level, fault handling and/or processing, are included in U.S. Pat. No. 7,351,151 entitled “Gaming Board Set and Gaming Kernel for Game Cabinets” and provisional U.S. Patent App. No. 60/313,743, entitled “Form Fitting Upgrade Board Set For Existing Game Cabinets,” filed Aug. 20, 2001, both patent and provisional application are incorporated by reference herein in their entirety.

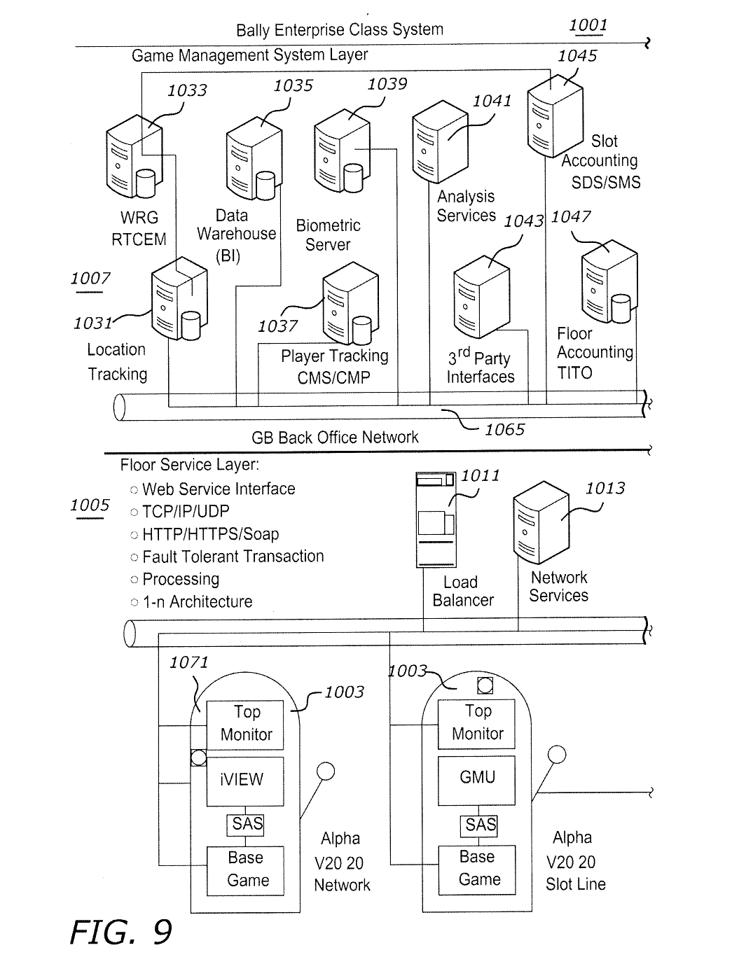

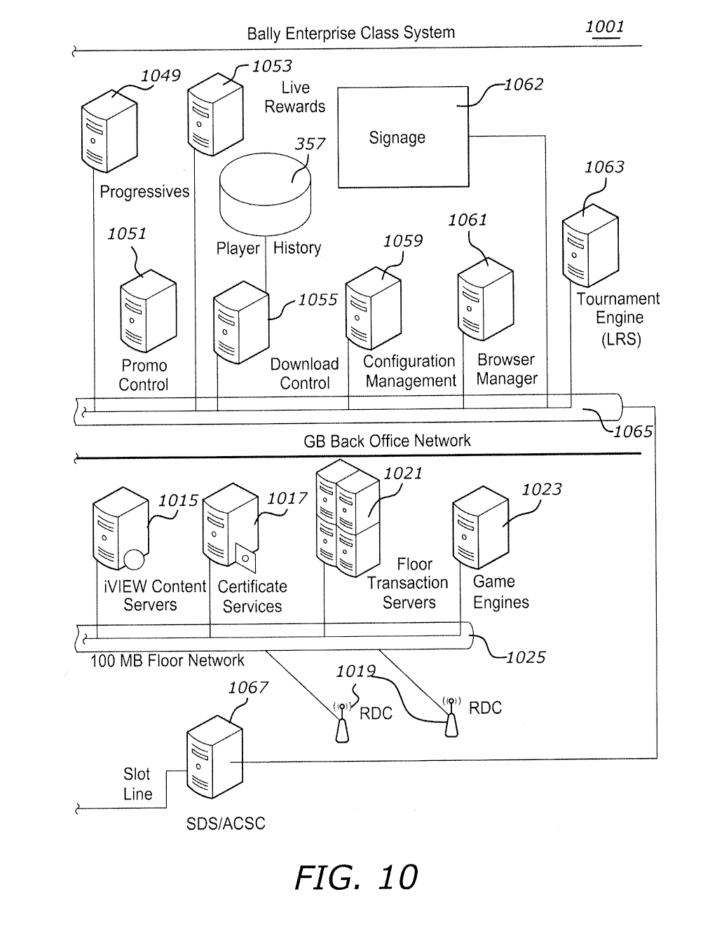

Referring to FIGS. 9 and 10, enterprise gaming system 1001 is shown in accordance with one or more embodiments. Enterprise gaming system 1001 may include one casino or multiple locations and generally includes a network of gaming machines 1003, floor management system (SMS) 1005, and casino management system (CMS) 1007. SMS 1005 may include load balancer 1011, network services servers 1013, player interface (iVIEW) content servers 1015, certificate services server 1017, floor radio dispatch receiver/transmitters (RDC) 1019, floor transaction servers 1021 and game engines 1023, each of which may connect over network bus 1025 to gaming machines 1003. CMS 1007 may include location tracking server 1031, WRG RTCEM server 1033, data warehouse server 1035, player tracking server 1037, biometric server 1039, analysis services server 1041, third party interface server 1043, slot accounting server 1045, floor accounting server 1047, progressives server 1049, promo control server 1051, feature game (such as Bally Live Rewards) server 1053, download control server 1055, player history database 1057, configuration management server 1059, browser manager 1061, tournament engine server 1063 connecting through bus 1065 to server host 1067 and gaming machines 1003.

The various servers and gaming machines 1003 may connect to the network with various conventional network connections (such as, for example, USB, serial, parallel, RS485, Ethernet). Additional servers which may be incorporated with CMS 1007 include a responsible gaming limit server (not shown), advertisement server (not shown), and a control station server (not shown) where an operator or authorized personnel may select options and input new programming to adjust each of the respective servers and gaming machines 1003. SMS 1005 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 1003 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 1007 and/or SMS 1005 servers and devices, firmware, media, operating systems, and configurations may be downloaded to the system components of respective gaming machines for upgrading or managing floor content and offerings in accordance with operator selections or automatically depending upon CMS 1007 and SMS 1005 master programming. The data and programming updates to gaming machines 1003 are authenticated using conventional techniques prior to installation on the system components.

In various embodiments, any of the gaming machines 1003 may be a mechanical reel spinning slot machine, video slot machine, video poker machine, keno machine, video blackjack machine, or a gaming machine offering one or more of the above-described games, including a group play game. Alternately, gaming machines 1003 may provide a game with a skill-based component as a primary or base game or as one of a set of multiple primary games selected for play by a random number generator, as described above. A gaming system of the type described above also allows a plurality of games in accordance with the various embodiments of the social-media enhanced kiosk system 100 to be linked under the control of a group game server (not shown) for cooperative or competitive play in a particular area, carousel, casino or between casinos located in geographically separate areas. For example, one or more examples of group games under control of a group game server are disclosed in U.S. patent application Ser. No. 11/938,079, entitled “Networked System and Method for Group Play Gaming,” filed on Nov. 9, 2007, which is hereby incorporated by reference in its entirety for all purposes.

### Tournament Gaming System Using Social Network Based Team Formation:

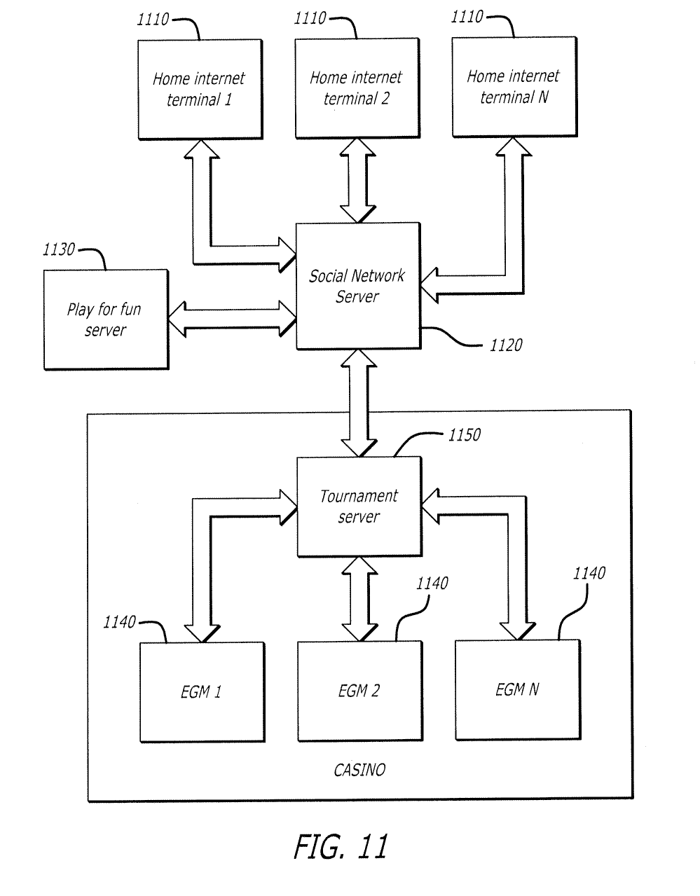

Referring now to FIGS. 11-13, the following disclosure is related to various embodiments of a Tournament Gaming System employing Social Network-Based Team Formation 1100 that uses the normally non-paying points as an incentive for players to return to the casino for further play. As discussed above, a leaderboard is typically maintained of the highest scores attained by players during the bonus feature.

In one aspect of the Tournament Gaming System employing Social Network Based Team Formation 1100, multiple leaderboards may be maintained. While each EGM may maintain its own individual leaderboard, in some embodiments casino-wide or bank-wide leaderboards are maintained and displayed, either on signage, or periodically on each EGM.

In one embodiment of the Tournament Gaming System employing Social Network Based Team Formation 1100, the casino-wide leaderboards are used for periodic tournaments. Preferably, multiple leaderboards are maintained so that different skill, bet, or club level players may be matched against each other. A preferred technique for implementation is described below.

In one aspect of the Tournament Gaming System employing Social Network Based Team Formation 1100, while players may play as an individual, gaining a high score only for bragging rights, they may also play as part of a team. As a team, they are eligible to enter the periodic tournaments organized by the casino. In a basic scenario, a casino may elect to run a tournament over a period of time (e.g., a weekend). As players within teams play the gaming machines with the bonus game, scores are posted onto the leaderboard. The teams with the highest scores at the end of the tournament period win the prizes.

One embodiment of the Tournament Gaming System employing Social Network Based Team Formation 1100 optimally uses social networks to enable players to form teams. Preferably an existing social network such as Facebook is used. One embodiment of the configuration of the system 1100 is shown in FIG. 11. In FIG. 11, users connect to a social network server 1120 from internet terminals 1110. As shown, in one embodiment the terminals may be located in the home as web browsers, but in other embodiments the primary access devices are smart phones (not shown), running either dedicated applications or mobile browsers.

Players may access a “Play for Fun” (PFF) version of the game via the social network server 1120. Typically, this application is hosted on a separate server 1130, which interfaces to the social network server 1120 using standard APIs such as Facebook. The PFF version may differ from the conventional casino game in that it only consists of the skill bonus round, and no cash prizes may be awarded. Alternatively, the PFF version may be a free-to-play version of the casino game, periodically awarding entry into the bonus round as happens in the casino. In this scenario, players may only have a limited number of free play credits per day, and to obtain more credits they may purchase them as In-App-Purchases (IAP). While players may purchase additional credits to practice more, in the PFF version of the game there are never prizes awarded. The PFF game enables the Tournament Gaming System 1100 to attract players to the tournament, and by extension to the casino, allowing them to practice away from the casino, and providing a means for players to measure their skill against other players and other teams.

The social network server 1120 also hosts one or more leaderboards for each casino with which it has an association. For example, a casino may have a “Facebook Page” (FP), and within this page one or more leaderboards may be displayed for tournaments in progress. Icons may also be displayed on the FP to allow players to initiate the creation of a team, or joining an existing team.

Teams are an important aspect of the Tournament Gaming System employing Social Network Based Team Formation 1100. Players form teams that compete in a tournament to gain the highest score playing the bonus game in the casino. Unlike conventional slot tournaments, which force players to play concurrently over a short period of time, in the Tournament Gaming System employing Social Network Based Team Formation 1100, the tournament period is expected to last a period of days, and players within teams may make single or multiple visits to the casino during this period to post a score.

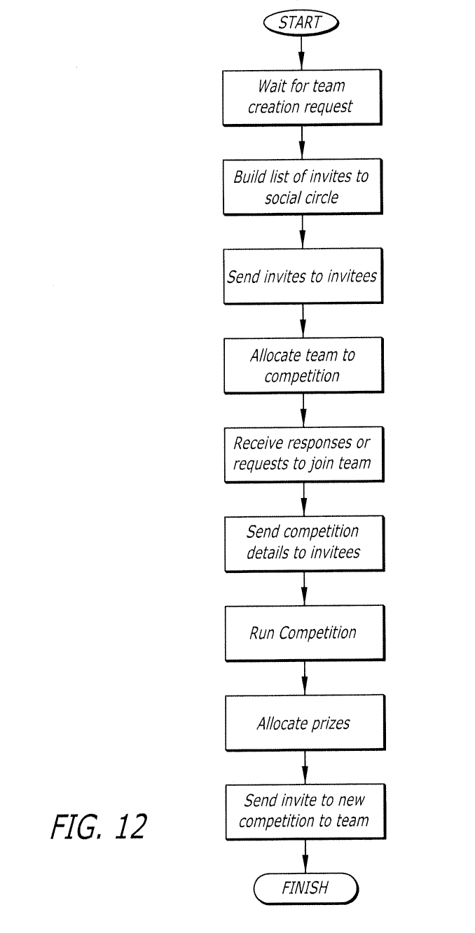

The basic lifecycle of one embodiment of a tournament is shown in FIG. 12. First, a player forms a team, initially consisting solely of themselves. In some implementations this is done by the player selecting “form team” from a user interface presented on the casino's FP. The player is then given the opportunity to issue invitations to join the team to friends in their friends list, via email, or other contact methods. By leveraging existing social networks, the Tournament Gaming System employing Social Network Based Team Formation 1100 makes it much easier for players to form teams. The invitations are sent to other potential team members and then the team is allocated to a tournament. Initially, a team consisting of new players is allocated to a default tournament, but over time other tournaments may be chosen depending upon some criteria.

In one embodiment of the Tournament Gaming System Using Social Network Based Team Formation 1100, multiple tournaments may overlap such that when a team is allocated to a tournament, the tournament is not yet started. While a team must be enrolled in a tournament before it begins to be eligible for prizes, it may be preferable that team members may be able to respond to the invitation after the tournament begins. Thus, a team may continue to grow in size. Regardless of how formation occurs, in some embodiments individual team members may only be members of one team in a particular casino at any one time.

As each team member joins the team, they are sent an email or other type of message giving them information on the tournament and the social network webpage with which it is associated. Members may use this information to track the tournament leaderboards as they are updated on the social network.

During the tournament period, players are encouraged to visit the casino and participate. Team creators may send messages to their team giving such encouragement, and the casino may auto-generate messages to teams that are jockeying for winning positions. In this manner, as the lead changes the new and old leading teams may be informed.

In another aspect of the Tournament Gaming System employing Social Network Based Team Formation 1100, the system enables teams to be formed of arbitrary size. To achieve this type of team formation, in one embodiment a team creator may invite as many friends as they like to join the team. Each of these members may join and play the game. During the tournament, only the current top N (e.g., five) team member high scores are used to compute an aggregate team high score. This embodiment does not discriminate against teams of at least a minimum size, while allowing teams to not have to be of a fixed size. In this manner, teams of various sizes may compete against each other by only using a top few number of scores. For example, a team of five may compete against a team of eight and a team of twelve. In this scenario, the top five scores of each team could be used for the competition. In other embodiments, alternative methods of ranking teams in tournaments may use the mean score of team members, the mean score of the top N members, or different weightings for different team sizes.

Many gaming advances are designed to increase the total coin-in. While the tournament in itself encourages more play, in some embodiments it is advantageous to weigh team member contributions by average or instant bet at the time of playing the bonus round. In this manner, a player betting five (5) credits per line may be given a bonus score that is five (5) times the score of someone betting one credit per line. Alternatively, a fixed bonus amount may be given to players depending upon their bet at the time of the bonus round.

In a further enhancement, players may be given additional bonus amounts or multipliers to their score depending upon their loyalty club level. A platinum level player may therefore be given a higher multiplier than a silver level player. In yet another embodiment, players may be given additional bonus amounts or multipliers to their score depending upon a combination of multiple factors, including by way of example only, and not by way of limitation, their loyalty club level, instant bet, average bet, and the like. At the end of the tournament period, the leaderboard is used to determine prizes to be awarded. Prizes may be awarded for the highest scoring team(s) and also possibly for the highest scoring individual members of teams.

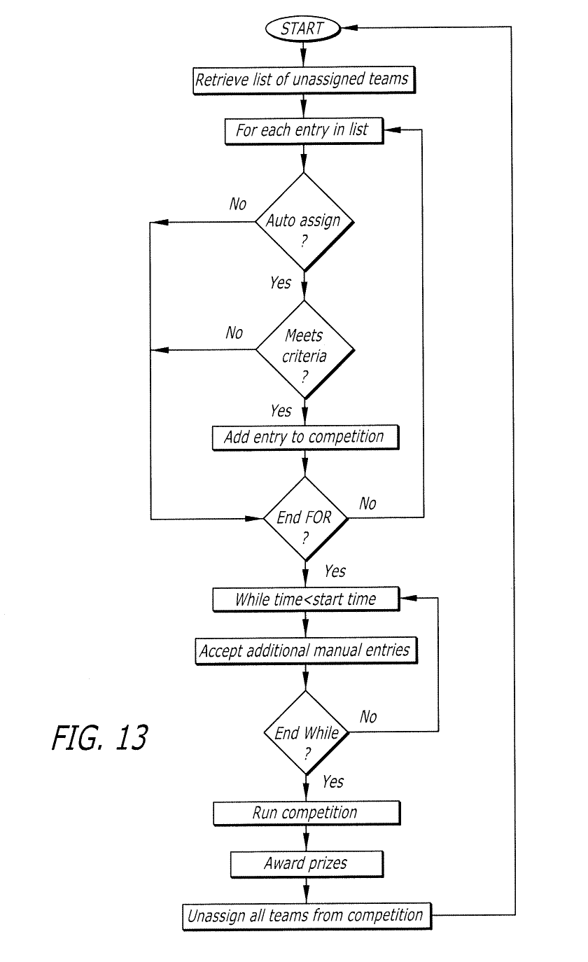

As described with respect to FIG. 13, once prizes are awarded, teams may be automatically entered into new competitions. In some embodiments, as teams finish a tournament, a list is generated of these teams for assignment to new tournaments. In such an embodiment, in the event of a casino running multiple tournaments concurrently, more than one tournament may finish at or around the same time (e.g., at the end of the weekend). Accordingly, the process shown in FIG. 13 may only be run periodically to ensure that teams from multiple tournaments may be considered for a new tournament.

In one embodiment, a reason for considering teams from multiple tournaments relates to the variance between team performances. As such, it is a feature of some embodiments of the Tournament Gaming System employing Social Network Based Team Formation 1100 that tournaments are “balanced” according to some criteria, with similar teams being matched together. Some examples of balancing criteria include the following which are listed by way of example only, and not by way of limitation. Regarding a first balancing criteria, teams with similar tournament scores are matched together. These balancing criteria make tournaments more competitive. Regarding a second balancing criteria, teams with similar total bets throughout the last tournament they participated in are matched together. This balancing criteria enables teams with excess members (who do not contribute to the highest scores) to participate in higher stakes tournaments. Regarding a third balancing criteria, teams with higher club level memberships are matched together. These balancing criteria encourage higher overall slot play to participate in higher prize tournaments. Regarding a fourth balancing criteria, teams that have won a tournament in a previous period of time are matched together. These balancing criteria enable a “champion of champions” tournament to be held for a higher prize or bragging rights.

Embodiments of the system 1100 that use balancing techniques enable players and teams to “find their own level.” Lower stakes players may still compete against each other, but higher skilled teams may be encouraged to bet higher so that they may compete for bigger prizes against other high skill teams. In some embodiments, some tournaments are only available to certain classes of players (e.g., platinum players only, or at least one platinum member per team).

Prizes for winning tournaments need not be cash-based in accordance with embodiments of the system 1100. A tournament for gold club level players may offer the chance to win platinum level privileges for a period of time. In one embodiment, club point multipliers may be won if a player is part of a team that wins a 2X multiplier, then all points they earn in the player club for the next week are multiplied by two. In some embodiments, cash-based prizes may be funded using marketing funds, or other funds not related to the “coin-in” of the gaming machines being played.

Returning to the process shown in FIG. 13, in some embodiments, some teams may elect to be automatically assigned to the best tournament available (i.e., the one with the largest prize). In other embodiments, other team leaders may elect to have their team not automatically assigned. Instead, after a tournament finishes they may manually enter any tournament for which they are eligible. In this case, while they may not be eligible for high prize tournaments if their skill, bet or club membership level does not support such tournaments level access, the players may also not be eligible for lower prize tournaments if their skill level has proven to be of too high a standard. So long as multiple tournaments are running concurrently, this prevents high skill players from preying on weaker teams, in some embodiments of the Tournament Gaming System Using Social Network Based Team Formation 1100.

In some embodiments of the Tournament Gaming System Using Social Network Based Team Formation 1100, players may form teams at home, but must return to the casino to play the game and win prizes. Advantageously, the system 1100 uses existing social networks to leverage pre-existing relationships between players to form teams. The use of existing social networks also makes developing tournament user interface easier by employing a non-gaming platform. Continuing, the system 1100 balances multiple competitions to maintain player interest and match suitable sets of players. In one embodiment, the Tournament Gaming System Using Social Network Based Team Formation 1100, encourages use of player cards such that players must associate a player card number with their Facebook account to participate in a team. Moreover, the free-to-play game feature of the system 1100 encourages players to try the game for real and to practice without cost.

In one embodiment of the Tournament Gaming System Using Social Network Based Team Formation 1100, an EGM runs the Total Blast game bonus (or other similar game). In another embodiment of the Tournament Gaming System Using Social Network Based Team Formation 1100, an Ethernet connection links each gaming machine 1140 to a tournament server 1150. In still another embodiment of the Tournament Gaming System Using Social Network Based Team Formation 1100, an internet-based social network application, hosted on an external server, provides the free-to-play version of the bonus game, team management for users, displays current high scores from tournament server 1150, and sends team information to the tournament server.

One embodiment of the Tournament Gaming System Using Social Network Based Team Formation 1100 enables: (1) forming teams on social networks to play at a casino; (2) balancing multiple tournaments based on criteria such as skill, bet, and player club level; (3) implementing a practice version of a game on a non-gaming platform to allow players to hone their skills for later tournament participation; (4) implementing a practice version of a game that consists only of a bonus round, and no underlying casino game; and (5) updating scores from gaming machines to social network to allow notification of tournament status to players away from casino.

Those skilled in the art will readily recognize various modifications and changes that may be made to the claimed invention without following the example embodiments and applications illustrated and described herein, and without departing from the true spirit and scope of the claimed invention.

What is claimed is:

1. A method of enabling a player to use a social-media enhanced kiosk system to obtain an enhanced casino gaming experience using personal player data from a social network, the method comprising:
enabling a player to access the social-media enhanced kiosk system via a user interface;
enabling a social account of the player on a social network to be accessed, wherein social data is retrieved from the social account of the player on the social network and transferred to a database within the social-media enhanced kiosk system;
formatting and storing the social data, wherein the social data is stored as a transaction and associated with a transaction type and player account;
processing the social data and transaction type;
loading a data queue with the processed social data, wherein the social data is associated with an access token and transaction type; and
enabling asynchronous queue polling of the processed social data.

2. The method of claim 1, wherein a change in relationship status attribute acquired from a player's social network account results in a personalized greeting or a promotional opportunity from the casino.

3. The method of claim 1, wherein a religion attribute acquired from a player's social network account results in a thematic change to the player's gaming experience or a promotional opportunity from the casino.

4. The method of claim 1, wherein a language attribute acquired from a player's social network account results in a linguistic change to the player's gaming experience.

5. The method of claim 1, wherein the social-media enhanced kiosk system enables casinos to continuously acquire personal player data for a player database from the player's account on a social network.

6. The method of claim 1, wherein the social-media enhanced kiosk system enables players to have registration screens at a casino prefilled using social data from the player's account on a social network.

7. The method of claim 1, wherein a social network user object has the following vital fields: locale, gender, favorite teams, favorite athlete, interested in, birthday, age range, languages, religion, relationship status, work, location, hometown, education, email, devices, and currency.

8. The method of claim 1, wherein the social-media enhanced kiosk system includes a social integrator component that processes, generates, and aggregates data in a preference database.

9. The method of claim 1, wherein processed social data is sent back to a server for storing in a data queue that is indexed with unique keys.

10. The method of claim 9, wherein clients use the unique keys to uniquely identify queued data for fetching and using the processed social data.

11. A method of enabling a player to use a social-media enhanced kiosk system to obtain an enhanced casino gaming experience using player preference data from a social network, the method comprising:
enabling a player to access the social-media enhanced kiosk system;
enabling a social account of the player on a social network to be accessed, wherein social data is retrieved from the social account of the player on the social network and transferred to a database within the social-media enhanced kiosk system;
formatting and storing the social data;
processing the social data;
loading a data queue with the processed social data; and
enabling asynchronous queue polling of the processed social data in the social-media enhanced kiosk system.

12. The method of claim 11, wherein a change in relationship status attribute acquired from a player's social network account results in a personalized greeting or a promotional opportunity from the casino.

13. The method of claim 11, wherein a religion attribute acquired from a player's social network account results in a thematic change to the player's gaming experience or a promotional opportunity from the casino.

14. The method of claim 11, wherein a language attribute acquired from a player's social network account results in a linguistic change to the player's gaming experience.

15. The method of claim 11, wherein the social-media enhanced kiosk system enables casinos to continuously acquire personal player data for a player database from the player's account on a social network.

16. The method of claim 11, wherein the social-media enhanced kiosk system enables players to have registration screens at a casino prefilled using social data from the player's account on a social network.

17. The method of claim 11, wherein a social network user object has the following vital fields: locale, gender, favorite teams, favorite athlete, interested in, birthday, age range, languages, religion, relationship status, work, location, hometown, education, email, devices, and currency.

18. The method of claim 11, wherein the social-media enhanced kiosk system includes a social integrator component that processes, generates, and aggregates data in a preference database.

19. The method of claim 11, wherein processed social data is sent back to a server for storing in a data queue that is indexed with unique keys.

20. The method of claim 19, wherein clients use the unique keys to uniquely identify queued data for fetching and using the processed social data.

21. A method of enabling a player to use a social-media enhanced kiosk system to obtain an enhanced gaming experience using player preference services, the method comprising:
enabling a player to access the social-media enhanced kiosk system;
enabling a social account of the player on a social network to be accessed, wherein social data is retrieved from the social account of the player on the social network and transferred to a database within the social-media enhanced kiosk system;
formatting and storing the social data;
processing the social data; and
enabling the processed social data in the social-media enhanced kiosk system to be searched.

22. The method of claim 21, wherein the player preference service takes a player account number and transaction type as inputs and returns one or more preference from the preference database.
